(19) United States
(12) Patent Application Publication
(10) Pub. No.: US 2020/0186863 A1
(43) Pub. Date: Jun. 11, 2020

(54) System and Method for Synchronizing of Data from Different Devices by Playback Time

(71) Applicant: OOO ITV Group, Moscow (RU)

(72) Inventor: Murat K. Altuev, Moscow (RU)

(21) Appl. No.: 16/574,119

(22) Filed: Sep. 18, 2019

(30) Foreign Application Priority Data
Dec. 6, 2018 (RU) 2018143322

(51) Int. Cl. H04N 21/43; H04N 21/4223; G11B 27/30; G08B 13/196; G08B 13/22

(52) U.S. Cl. CPC H04N 21/4307; H04N 21/4223; G08B 13/22; G08B 13/19669; G11B 27/3027

(57) ABSTRACT

The system for synchronizing by time the playback of data from different devices contains a data processing device, multiple different data-capture devices that capture and transmit data about their status and/or serve as data or event sources, memory, and graphical user interface. In the case when the computer system user selects and plays back the archive data received from one of the multiple data-capture devices and corresponding to a particular point of time in the past, all other system devices are synchronized by time with the data being played back and simultaneously playback/display their data corresponding to that particular point of time in the past through the display unit.

### RELATED APPLICATIONS

This application claims priority to Russian Patent Application No. RU 2018143322, filed Dec. 6, 2018, which is incorporated herein by reference in its entirety.

### FIELD OF THE INVENTION

The invention refers to the field of data visualization and more specifically to the technologies aimed at synchronous display of archived data from all devices of the security system at a set point of time.

### BACKGROUND

Surveillance systems are used for security and control of premises or areas. Most often these systems apply video cameras to track any events and movements of the objects. Video data received from VS cameras allows the security system operator to assess the situation in the protected area. Thus, the video surveillance systems are based on the image processing algorithms that enable analyzing the video without direct involvement of a person.

Recently, in addition to video cameras, security surveillance systems have also been using other devices capable of recording data on their status or collecting/transmitting data on events taking place in a specific area. Such devices may include, for example, access control and management systems (ACS), tag readers, sensors that transmit the objects position (trackers, bracelets), and so on. Such combined surveillance systems are quite illustrative, especially when monitoring takes place in real time. In addition, each of the system devices stores all the data in the archive, which, if necessary, can be viewed later.

Sometimes the system operator needs to review, analyze, and compare data from all system devices over a period of time in the past, for example, to confirm or disprove a violation. This can be a very time-consuming task for the operator, as viewing data from each of the system's devices can take a long time. At the same time, given the huge amount of data available, the operator will not be the events able to see/present the whole picture of what is going on, which means it will be difficult for the operator to assess the situation correctly without missing anything.

Thus, the main disadvantage of the previous state of art consists in the lack of full visualization of archived data from all devices over a certain period of time in the past.

From the background of the invention we know the solution disclosed in U.S. Pat. No. 9,659,598 B2, publ. 23 May 2017, which describes the options for managing the playback of data from multiple cameras. The described methods feature the setting of a timeline for several types of video data from different cameras for separate playback or for communication and synchronizing their playback.

Also, from the background of the invention, we know the solution disclosed in U.S. Pat. No. 8,438,131 B2, publ. 7 May 2013, which describes the systems and methods of data processing for synchronization of multiple media resources. In the context of this invention, a data archive containing many media resources related to events that occurred during a certain period of time interval is being processed for media synchronization. Each media resource of the archive identifies the template sequences. Sequence elements are correlated in such a way that the set of the correlated elements is associated with the same event that occurred in a given time interval. Information about synchronization of the processed media resources is presented in a flexible and extensible data format. Synchronization information is applied for further optimization of synchronous search options, for extended synchronous playback of archive resources, as well as for unified access to archive resources and their modification.

The main disadvantage of the solutions known from the background of the invention is the lack of playback time synchronization of data not only from cameras, but also from other devices of the security system. Due to this, the operator does not see the full picture of events which happened in the past.

### BRIEF SUMMARY

The claimed technical solution is aimed to eliminate the disadvantages of the previous background of the invention and develop the existing solutions.

The purpose of this technical solution is to recreate a complete picture of what was happening in the system at a given time for the system operator during viewing the archive.

The technical result of the claimed invention is increase of the speed of work with the archive by synchronous playback of archival data from all devices of the system, which provides full visualization of the archive data.

This technical result is achieved by design of the system for playback time synchronization of data received from different devices, which contains: at least one data processing device; multiple data capture devices that capture and transmit the data about their status and/or serve as data or event sources, whereby each of the mentioned data capture devices is linked to the site plan; memory device featuring the ability to store the data archive received from multiple data capture devices; graphic user interface featuring the ability to provide the user with system events and events from various data capture devices through the display block, whereby in the case when the system user selects and plays the archived data from one of the multiple data capture devices and corresponding to a specific point in time in the past, all others system devices synchronize with the played data by time and simultaneously play/display via their data corresponding to this specific point in time in the past through the display block.

This technical result is also achieved by the method of synchronizing the playback time of data from different devices implemented by the computer system and containing the stages at which: data from multiple different data capture devices that capture and transmit the data about their status and/or serve as data or event sources is received, whereby every mentioned data capture device is linked to the site plan; archive of data received from multiple data capture devices is saved in the computer system memory; system events and events from multiple data capture devices are presented to the user through the graphical user interface through the display unit, whereby in the case when the computer system user selects and plays the archived data received from one of the multiple data capture devices and corresponding to a particular point in time in the past, all other devices in the system are synchronized with the played data by time and simultaneously replay/display their data corresponding to this particular point in time in the past through the display block.

In one particular version of the claimed solutions, data capture devices can be at least one or a combination of the following devices:

video cameras;

access control system (ACS) readers;

RFID readers;

motion sensors;

barriers.

In another particular version of the claimed solutions, the following happens at synchronization with the played back data by time:

the system cameras start playing back the archived videos for the same period,

the site plan shows the current status of all data-capture devices for the same period,

all events that were received at that point in time are displayed synchronously with the data being played back, all the actions taken by the system operator at that point of time are displayed.

In another particular version of the claimed solutions, when the operator views the real-time data from one of the multiple data capture devices, all other system devices are also returned to real time mode.

In another particular version of the claimed solutions, the site plan is an image or geographic information system (GIS), such as an Open Street Map.

This technical result is also achieved by a computer-readable data carrier containing instructions executed by the computer processor for synchronization of data from different devices by playback time.

### BRIEF DESCRIPTION OF THE SEVERAL VIEWS OF THE DRAWINGS

FIG. 1—flowchart of the system for synchronizing the data from different devices by playback time.

FIG. 2—flowchart of one of the embodiment options for synchronizing the data from different devices by playback time.

### DETAILED DESCRIPTION

Description of the approximate embodiments of the claimed group of inventions is presented below. However, the claimed group of inventions is not limited only to these embodiments. It will be obvious to persons who are experienced in this field that other embodiments may fall within the scope of the claimed group of inventions described in the claim.

The claimed technical solution in its various embodiments may be implemented in the form of systems and methods for synchronizing the data from different devices by playback time.

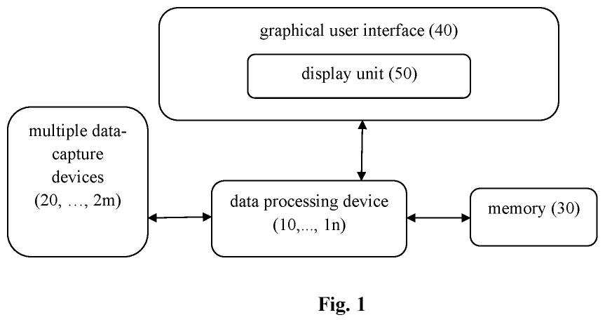

FIG. 1 shows a flowchart of one of the embodiment options for synchronizing the data from different devices by playback time. The mentioned system in its basic configuration includes: at least one data processing device (10, . . . , 1n), multiple different data-capture devices (20, . . . , 2m); memory (30); and graphical user interface (40) which contains a display unit (50). The display unit (50) is a data output tool, thus, it's obvious that the specified graphical user interface also contains the data input tools (not shown).

In this context, computer systems may be any hardware- and software-based computer systems, such as personal computers, smartphones, laptops, tablets, etc.

The data processing device in different design options can be arranged as: processor, microprocessor, computer, PLC (programmable logic controller), or integrated circuit.

Data-capture devices are any computing devices that can record and transmit the data about their status and/or that serve as data or event sources.

Memory devices may include, but are not limited to, hard disk drives (HDDs), flash memory, ROMs (read-only memory), solid state drives (SSDs), etc. The system memory stores the data received from all system devices in real time.

The graphical user interface (GUI) is a system of tools for user interaction with the computer system based on representation of all system objects and functions available to the user in the form of graphical screen components (windows, icons, menus, buttons, lists, etc.). Thus, the user has random access (through data input devices) to all visible screen objects—interface blocks—which are displayed on the screen (monitor).

It should be noted that the specified system can include any other devices known in the background of the invention. For example, data input devices that are, but are not limited to, mouse, keyboard, touchpad, stylus, joystick, trackpad, etc.

A specific example of operation of the aforementioned system for synchronizing the playback of data from different devices will be described below.

In order to support functioning of the above-mentioned computer system, many different data-capture devices receive, record, and transmit the data. In the context of this application, the data capture devices may be at least one or a combination of the following devices: video cameras; access control system (ACS) readers; radio frequency identification (RFID) tag readers; various motion sensors; barriers, etc. For example, let's assume a security system incorporates multiple cameras and several other data-capture devices that record and transmit the data about their status and/or serve as data or event sources.

Thus, the received/recorded data can be a video stream, in case of video cameras, or metadata if the data-capture device is, for example, the gauge or the object detector. Thus, the computer system memory is configured for storage of all data received from multiple various data-capture devices in different time, as well as for storage of all system data (events) received from data processing devices in the course of operator's work with the system. In one of the particular system embodiment options, all video data is analyzed in the process of loading into memory to form metadata characterizing the data about all the objects in the video. In this case, metadata is detailed information about all objects moving in the field of view of each camera (motion trajectories, facial descriptors, recognized license plate numbers of cars, etc.). The obtained metadata is also stored in the system memory.

In addition, the system memory stores the site plan. In order to further understand the nature of the proposed solution, it is necessary to clarify that the site plan is a kind of a topographic map or a drawing (picture) of a small area in a given scale. The site plan is either an image in a public available format or data from the geographic information system (GIS), such as an open street map (OpenStreetMap). In this case, all data-capture devices available in the system are linked to the site plan to carry out the further transformation of the moving object coordinates from the original data-capture device coordinate system to the coordinate system of the site plan.

The data received from the data-capture devices is sent to the data processing devices, as well as to the graphical user interface which displays the system events and all other events from the data-capture devices to the user through the display unit. It is easy to present, as an example, a conventional surveillance system with which the operator works in real time, views the data from various devices, and interacts with the system through GUI tools.

To disclose the basic idea of the invention, let's assume that the system operator needs to review all available data from the security system data archive for a specific period of time, for example, for the time interval between 8:00 and 15:00 on Sep. 23, 2017 (according to some data, an offence has been committed in that time interval).

To do this, the system operator opens the data archive and finds there, for example, a video record from one of the cameras for the required date and time. Once the video is selected and started, the playback starts.

In this case, not only the selected video is played back, but the entire security system “comes back to the past”: all other system devices are synchronized with the video data being played back and simultaneously play back (display) their data corresponding to that particular point in time in the past through the display unit.

Namely, when synchronized with the played back data by time, all other cameras of the system, if any, begin to play back the archive video records for the same period.

The site plan shown on the display unit displays the current status of all data-capture devices at that time. For example, the operator can see whether the barrier was opened or closed at that point in time in the past.

Thus, the system receives and displays all events that were received at that point in time, synchronously with the data being played back. For example, the system operator immediately sees all the events coming from the system readers at that point of time (whether an object has entered or exited the territory; whether an object was identified in one of the multiple check points in the protected area). In the context of this solution, an object is a person or a vehicle.

In addition to the above, all the actions taken by the system operator at that point of time are also displayed synchronously with the played back data from all system devices. That is, the operator is a kind of data source. Such data is initially collected by the data processor and stored in the data archive, as well as any other system data displayed by the system in real time without any involvement/request from the operator.

The above described time synchronization of absolutely all system devices allows the operator quickly and accurately assessing the situation that occurred at specific point of time/time period by viewing the full set of data, not just data from a single kind of data-capture devices, such as the video cameras or readers. This reduces the operator's time spent for manual work with the archive, due to the fact the operator does not need to manually run, view, and analyze the data from multiple devices of the system. The operator immediately sees all the data and its playback is started by the system automatically, synchronously with certain data for a particular date and time initially selected by the operator. Thus, the operator is completely immersed in the atmosphere of everything that happened in the protected area in the past.

It should be mentioned that when the operator views the real-time data from one of the multiple data capture devices, all other system devices are also returned to real time mode. That is, as soon as the operator returns to live viewing on one video camera, all other devices of the system also “return to real time” and begin to display the current data characterizing the current statuses and events.

The security system may not contain the video cameras. For example, there are security systems that contain only readers (ACSs and RFID) and barriers. In this embodiment of the system, the operator starts to play back the data which was, for example, received from an ACS reader, whereupon all other system devices are synchronized by time with the data being played back and start to play back their data synchronously.

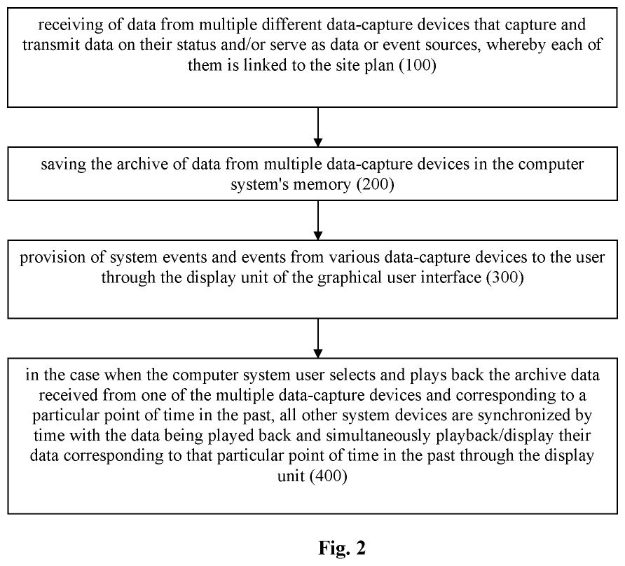

FIG. 2 shows a flowchart of one of the embodiment options for synchronizing the data from different devices by playback time. This method is carried out by the above described computer system and contains the following stages, at which:

Stage (100)—data from multiple different data-capture devices that capture and transmit data on their status and/or serve as data or event sources is received, whereby each of them is linked to the site plan;

Stage (200)—archive of data from multiple data-capture devices is saved in the computer system's memory;

Stage (300)—system events and events from various data-capture devices are presented to the user through the display unit of the graphical user interface;

Stage (400)—whereby, in the case when the computer system user selects and plays back the archive data received from one of the multiple data-capture devices and corresponding to a particular point of time in the past, all other system devices are synchronized by time with the data being played back and simultaneously playback/display their data corresponding to that particular point of time in the past through the display unit.

It should be noted once again that this method is implemented by means of the previously described computer system of synchronization by time of the data playback from various devices and, therefore, can be expanded and refined by all particular versions that have been already described above for embodiment of this computer system.

Besides, the embodiment options of this group of inventions can be implemented with the use of software, hardware, software logic, or their combination. In this embodiment example, software logic, software, or a set of instructions are stored on one or multiple various conventional computer-readable data carriers.

In the context of this description, a “computer-readable data carrier” may be any environment or medium that can contain, store, transmit, distribute, or transport the instructions (commands) for their application (execution) by a computer device, such as a personal computer. Thus, a data carrier may be a volatile or a non-volatile machine-readable data carrier.

If necessary, at least some part of the various operations presented in the description of this solution can be performed in an order differing from the described one and/or simultaneously with each other.

Although the technical solution has been described in detail to illustrate the most currently required and preferred embodiments, it should be understood that the invention is not limited to the embodiments disclosed and, moreover, is intended to modify and combine various other features of the embodiments described. For example, it should be understood that this invention implies that, to the possible extent, one or more features of any embodiment option may be combined with one or more other features of any other embodiment option.

1. The system for synchronizing by time the playback of data from different devices, comprising:
at least one data processing device;
multiple different data-capture devices that capture and transmit data on their status and/or serve as data or event sources is received, whereby each of them is linked to the site plan;
memory featuring the option for saving the archive of data received from multiple data-capture devices;
graphical user interface featuring the option for provision of system events and events from various data-capture devices to the user through the display unit,
thus, in the case when the computer system user selects and plays back the archive data received from one of the multiple data-capture devices and corresponding to a particular point of time in the past, all other system devices are synchronized by time with the data being played back and simultaneously playback/display their data corresponding to that particular point of time in the past through the display unit.

2. The system of claim 1, wherein the data-capture devices can be at least one or a combination of the following devices:
video cameras;
access control system (ACS) readers;
RFID readers;
motion sensors;
barriers.

3. The system of claim 2, wherein following features at time synchronizing with the played back data:
a) the system cameras start playing back the archived videos for the same period,
b) the site plan shows the current status of all data-capture devices for the same period,
c) all events that were received at that point in time are displayed synchronously with the data being played back,
d) all the actions taken by the system operator at that point of time are displayed.

4. The system of claim 3, wherein the operator views the real-time data from one of the multiple data capture devices, all other system devices are also returned to real time mode.

5. The system of claim 4, wherein the site plan is an image or a geographic information system (GIS), for example, an Open Street Map.

6. The method for synchronizing by time the playback of data from different devices implemented by the computer system and comprising the stages at which:
data from multiple different data-capture devices that capture and transmit data on their status and/or serve as data or event sources is received, whereby each of them is linked to the site plan;
archive of data from multiple data-capture devices is saved in the computer system's memory;
system events and events from various data-capture devices are presented to the user through the display unit of the graphical user interface;
whereby, in the case when the computer system user selects and plays back the archive data received from one of the multiple data-capture devices and corresponding to a particular point of time in the past, all other system devices are synchronized by time with the data being played back and simultaneously playback/display their data corresponding to that particular point of time in the past through the display unit.

7. The method of claim 6, wherein the data-capture devices can be at least one or a combination of the following devices:
video cameras;
access control system (ACS) readers;
RFID readers;
motion sensors;
barriers.

8. The method of claim 7, wherein following features at time synchronizing with the played back data:
a) the system cameras start playing back the archived videos for the same period,
b) the site plan shows the current status of all data-capture devices for the same period,
c) all events that were received at that point in time are displayed synchronously with the data being played back,
d) all the actions taken by the system operator at that point of time are displayed.

9. The method of claim 8, wherein the operator views the real-time data from one of the multiple data capture devices, all other system devices also return to the real time mode.

10. The method of claim 9, wherein the site plan is an image or a geographic information system (GIS), for example, an Open Street Map.

11. Non-transitory computer readable medium storing instructions that, when executed by a computer, cause it to perform the method of claim 6.
